(19) United States
(12) Patent Application Publication
(10) Pub. No.: US 2026/0010392 A1
(43) Pub. Date: Jan. 8, 2026

(54) ENHANCING EDGE DEVICES PROBLEM-SOLVING IN COLLABORATIVE EDGE ARCHITECTURES

(71) Applicant: Dell Products L.P., Round Rock, TX (US)

(72) Inventors: Karen Braga Enes, Belo Horizonte (BR); Diego Vrague Noble, Pelotas (BR)

(21) Appl. No.: 18/763,430

(22) Filed: Jul. 3, 2024

(51) Int. Cl. G06F 9/48; H04L 41/40

(52) U.S. Cl. CPC G06F 9/4843; H04L 41/40

(57) ABSTRACT

Communication and task execution in a collaborative manner is disclosed. When a task is received, the task type is determined along with an archetypal device. Next, network-based communities are determined from a graph representing devices in a network. The graph is then searched to identify devices that are compatible with the task and the archetypal device. These devices represent a task-based network. The task-based network and the network-based communities are aligned. This may include establishing connections and network functions, such as virtual private networks and virtual network functions such that alignment is achieved. The task may be performed collaboratively by the devices in the task-based network after alignment.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to device collaboration in edge systems and task solving in collaborative edge systems. More particularly, at least some embodiments relate to systems, hardware, software, computer-readable media, and methods for device communication and collaborative task execution among devices in computing environments.

### BACKGROUND

Devices in edge systems play a role in providing a computing environment in physical locations that are closer to users and data compared to more remote data centers. Edge systems bring computation, storage, and networking capabilities closer to the source of data (or user) or location where computing may be required. At the same time, edge devices usually have limited data transmission and/or processing capabilities due to their limited computational resources. In this sense, devices in an edge system or at the edges can benefit from a collaborative approach to problem-solving when communication and information sharing are facilitated. This is also true for devices that are aiming to solve or perform the same or similar tasks.

The increased availability of cloud storage and cloud computing is associated with the proliferation of devices that rely on cloud storage and cloud computing. It is useful, for example, to offload computation-intensive tasks from edge devices to more computationally powerful cloud datacenters or High-Performance Computing (HPC) servers. As previously stated, however, cloud computing is often remote from devices that require computing resources.

As a result, attempts have been made to bring computing closer to the user. Device to device (D2D) edge is an approach that aims to leverage idle devices in order to solve problems or perform tasks collaboratively. Even if D2D is able to leverage devices in the same network, not all problems fit this scenario and D2D does not address device capability from a network and task perspective.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of a network in which task orchestration may be performed collaboratively;

FIG. 1B discloses aspects of network-based communities and community detection in graph representations of devices in a network;

FIG. 2 discloses aspects of orchestrating tasks in a computing environment that includes network-based device communities;

FIG. 3 discloses aspects of orchestrating tasks, which may include aspects of aligning network and task-based communities;

FIG. 4 discloses aspects of a method for orchestrating tasks in a computing environment;

FIG. 5 illustrates an example of pseudocode for orchestrating tasks in a computing environment; and

FIG. 6 discloses aspects of a computing device, system, or entity.

### DETAILED DESCRIPTION OF SOME EXAMPLE EMBODIMENTS

Embodiments disclosed herein generally relate to collaborative devices, systems and architectures. More particularly, at least some embodiments relate to systems, hardware, software, computer-readable media, and methods for orchestrating tasks in computing networks and generating aligned community and task-based communities for collaborative computing.

Embodiments of the invention relate to virtual networking operations, community detection operations, and graph search operations to facilitate and improve communication and collaboration among edge devices in a networked scenario. Embodiments of the invention allow for network-based communities and task-based communities to be detected, created and/or adjusted as needed in order to perform tasks in a collaborative manner. Because advantages can be obtained when devices are grouped by matching task capability and network communities, embodiments of the invention facilitate a collaborative network system.

In many instances, devices that are best suited to solve or perform similar tasks may be spread out in a network. Embodiments of the invention identify and group devices such that similar tasks may be performed collaboratively.

More specifically, a network-based community refers, by way of example only, to the topological positions of devices or nodes in a graph. A task-based community refers, by way of example only, to grouping devices based on the types of tasks the devices are configured to solve or capable of solving. However, a network-based community may not always align or match with a task-based community. Embodiments of the invention mitigate mismatches, in one example, by suggesting (and implementing) new connections and bridges. This facilitates communication patterns by improving virtual networking resources, throughput, connection available, and/or latency.

In one example, embodiments of the invention are discussed in the context of the following configurations or assumptions. Embodiments of the invention are not limited thereto. Embodiments of the invention are further discussed in the context of edge devices and edge networks, but are not limited thereto. Embodiments of the invention may be applied to networks and devices connected thereto. An edge network may refer to a system that brings computing resources closer to a requesting device. Thus, edge networks may exist in the context of various types of wireless and wired networks including WiFi networks, cellular networks, or the like.

When devices are networked, embodiments of the invention enable the devices to collaborate to perform tasks (e.g., solve problems) from a network and/or task-based perspective. A task includes, by way of example, a problem that can be solved using computing resources based on available data. Tasks may have or be associated with hard and/or soft constraints. Hard constraints refer to constraints that must be satisfied while soft constraints are desirable or optimal. The granularity of the constraints may be defined by a user or set by default. The granularity may also be adjusted.

In general, tasks are solved (computed, executed) by an edge device. In one example, an edge device may be capable of solving different tasks, but may only be able to solve one task at a time. Each device may include or be associated with a table or structure (e.g., labels) identifying tasks the device is capable of solving or performing. This structure or labels allows edge devices to be grouped into task-based communities. Devices capable of solving a first type of task may be grouped into a task-based community for the first type of task. A device may be a member or included in multiple task-based communities. The edge device may benefit from directly exchanging information within their task-based grouping of devices.

Edge devices are typically connected in a network. The network may be modelled as an undirected graph in one example and each node of the graph represents exactly one unique edge device. Edge devices may also be grouped in communities by their topological position in the graph, which may be referred to as a network-based community.

However, the task-based community and the network-based community of a particular device may not necessarily match. Mismatches may impair or impact the ability of a system (or device) to perform a task or solve problems. More specifically, edge devices inside the same network-based community enjoy a better rate of communication (i.e., lower latency, higher throughput, high availability) due to network proximity and abundant paths. Edge devices that do not share the same network-based community have a penalty when exchanging information as their communication paths may include network bottlenecks. In general, inter-community communication is less effective compared to intra-community communication.

In one example, embodiments of the invention may include a centralized network control system or server (e.g., software defined network (SDN) based system) that is configured to monitor and manage network infrastructure. This may include expanding networks, managing (creating, monitoring, removing) virtual private networks (VPNs) and virtual network functions (VNFs), provisioning resources for VPNs and VNFs, or the like.

In some instances, an edge device may only be able to perform a single type of task. In some instances, if a device is currently executing a task and is required to execute a new task that consumes all or some of the reserved resources of the device, various resolutions may be performed. For example, execution of the task may need to wait until the device is free. Alternatively, embodiments of the invention may search for a similar device (or a similarly capable device).

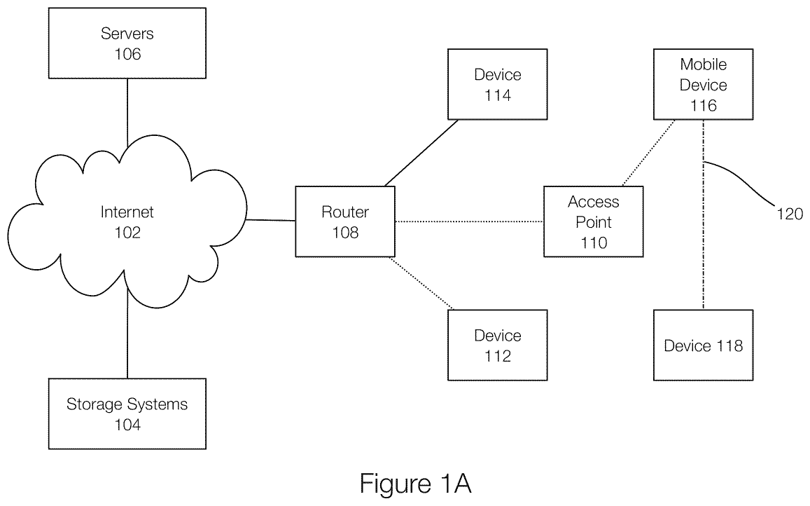

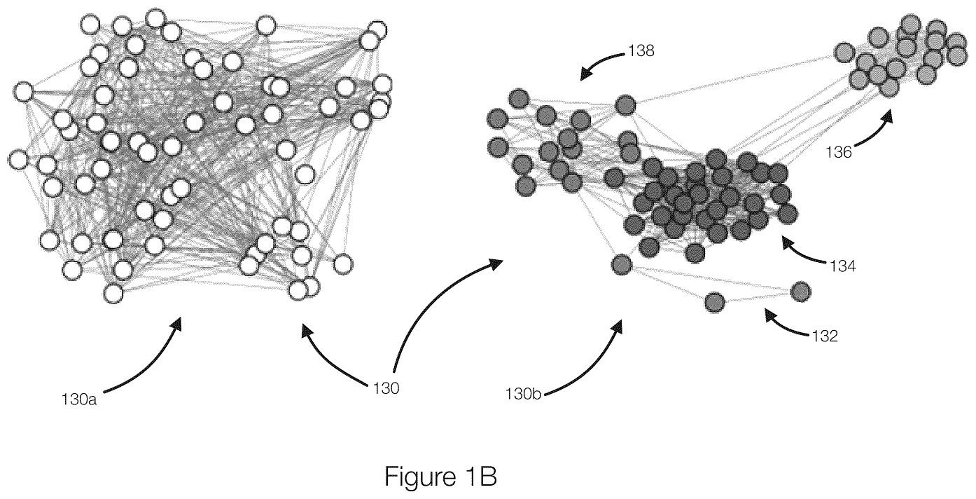

FIG. 1A discloses aspects of a network in which task orchestration may be performed and tasks are performed or solved in a collaborative manner. FIG. 1A illustrates a network (the Internet 102) that is associated with servers 106 and storage systems 104. A router 108 may be used by devices 112 and 114 to access the internet 102. An access point 110 may be used by a mobile device 116. The access point 110 may be connected to the router 108.

FIG. 1A illustrates at least two possible communication scenarios. More specifically, the mobile device 116, the device 112, and the device 118 may be capable of solving the same type of task. Thus, the mobile device 116, the device 112, and the device 118 may be in the same task-based community, but not in the same network-based community. As illustrated in FIG. 1A, a communication path (dotted line) exists between the mobile device 116 and the device 112. Thus, the mobile device 116 and the device 112 may be in the same network-based community. To solve this mismatch between the network and task-based communities, the connection 120 (dash-dot line) represents an ad hoc connection between the mobile device 116 and the device 118. This allows the network and task-based communities to be aligned, at least until the task is solved. Embodiments of the invention may configure network connections in the context of network-based communities and task-based communities to facilitate solving tasks.

FIG. 1B discloses aspects of network-based communities and community detection in graph representations of devices in a network. FIG. 1B illustrates a graph 130 as a random layout 130a and as a community layout 130b. These layouts 130a and 130b represent the same graph 130. However, the layout 130b represents the graph 130 after a community detection operation has been performed. This operation resulted in detection or identification of communities 132, 134, 136, and 138.

More specifically a graph may be a structure that is used to represent relationships (edges) between entities (vertices or nodes). The vertices or nodes of a graph may contain information about the entities being modeled and the information may be referred to as attributes. The vertices or nodes may also have characteristics or labels that may be used to target the nodes.

A graph may be searched for nodes with a particular label and thus capable of solving a particular type of task. Searching a graph refers to a process of traversing a graph, a subgraph, or a set of interconnected nodes in order to find one or more specific nodes or paths. If the graph 130 represents edge devices (and in other scenarios), searching the graph 130 or accessing data associated to the nodes of the graph 130 may be difficult and have a steep cost because the graph may be very large. However, a fraction of data to be modeled by a graph may be partially observed. Further, the search may be interested in target nodes or nodes with certain labels or characteristics. This allows a limited budget to be used more efficiently.

Active search on graphs is a technique for finding target nodes (i.e., nodes with a certain label or characteristic) in a network by querying nodes in a graph, under a query budget constraint. Nodes have labels or labels that may not be observable, but the network topology and edge weights are fully observable, and any node can be queried at any time. Active search is an attempt to discover as many members of a certain label (type or class) as possible using a limited budget. Active search is an example of a method for identifying a task-based community.

A common phenomenon in many network is the emergence of regions of heavily interconnected nodes. These graph clusters may be referred to as communities. More specifically, this common kind of community is called an assortative community. There are many mechanisms by which connections are established in networks. The most common mechanism is homophily, which is present whenever a new node in the network prefers to connect to similar nodes according to a criterion. For instance, new nodes may form a community in a computer network because they connect to a geographically closer switch.

Community detection such as the Girvan-Newman Algorithm or the Hierarchical Clustering family of algorithms can detect hierarchies of communities. Alternative algorithms can perform community detection in dynamic and heterogeneous networks.

Embodiments of the invention relate to collaborative communication or computing. Embodiments of the invention relate to a pipeline or method that allow devices (e.g., edge devices) to be grouped automatically according to task-based communities. This may also include reinforcing or creating connections in an inter-community and/or intra-community manner.

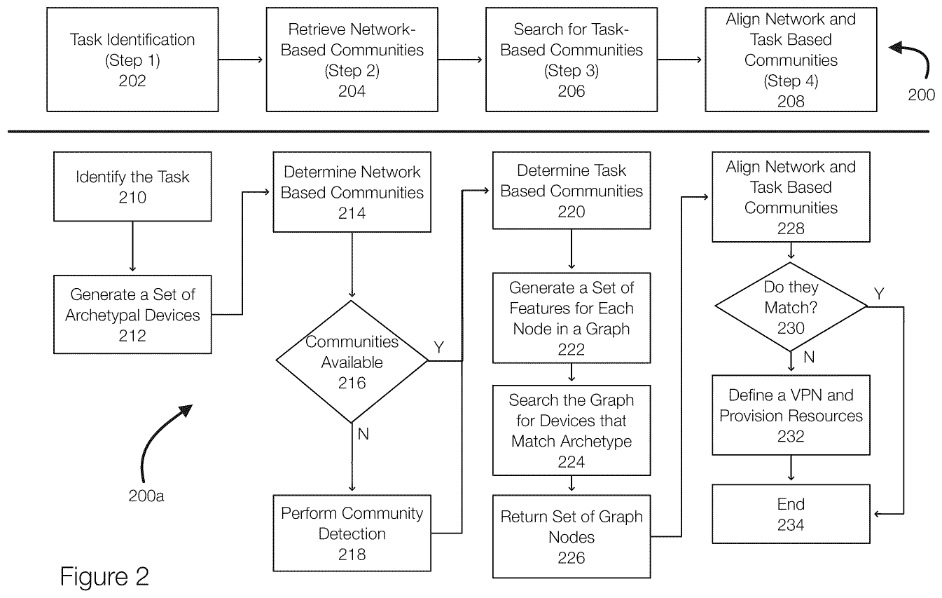

FIG. 2 discloses aspects of orchestrating tasks in a computing environment that includes network-based device communities. The method 200, by way of example only, includes task identification 202 or step 1. Task identification 202 generally include identifying the task to be solved and generating a set of archetypal devices that are suited to solve the task.

The method 200 includes retrieving 204 network communities or step 2. Network communities may be retrieved, in one example, using assortative community detection operations. This allows subsets of nodes in a network that are tightly and densely connected to be identified as network-based communities.

The method 200 includes employing search techniques 206 to identify task-based communities or step 3. In one example, active search is employed to find a set (or all) devices that match the archetypes previously identified in step 1. The match is not require to be exact, though an exact match may be beneficial. However, the match should satisfy hard and soft constraints related to the device's computational power and feature sets (e.g., accelerators, sensors, Neural Processing Units (NPUs)).

The method 200 includes aligning 208 the network and task-based communities or step 4. Aligning the network and task-based communities may include network management operations such as, but not limited to, one or more of defining networks (e.g., VPNs), provisioning resources to serve VPNs and VNFs, applying rewiring operations to improve inter-community connectivity, optimizing traffic, allocating bandwidth, avoiding congested routs, or the like

FIG. 2 also illustrates a more detailed method 200a (an example of the method 200) that illustrates additional aspects of steps 1-4. In step 1, the task to be performed or orchestrated is identified 210. This may include determining or generating 212 a set of archetypal devices. As previously discussed, each edge device can solve a set of specific tasks and edge devices that can solve similar tasks benefit from collaboration. Collaboration includes, by way of example, solving the same problem or task while exchanging information as needed about the problem (or pieces of it) and/or about the solution (or pieces of it).

By identifying 210 the task to be solved, a set of archetypal devices can be generated 212 that are suitable for solving the same task. An archetypal device, by way of example, includes virtual devices that have a subset of features that can be matched against real devices. An archetypal device could be, for instance, the following description: “a high-definition video recording capable device”. This description could be matched against a smartphone or a surveillance camera, which are real devices. Other archetypal devices can be added if needed.

In one example embodiment, a pool of archetypal devices may be predefined. If a new archetypal device is needed, this pool may be refreshed to better guide the search of the graph. Additionally, new archetype definitions may be received together with the task. These archetypes can be included with the predefined pool of archetypal devices and then removed after the last step 4 if desired. In another embodiment, predefined archetypal devices are defined in a hierarchical way with types lower in the tree being the more fine-grained archetypal devices.

Once, the set of archetypal devices is determined or generated in step 1, the method 200a may determine 214 network-based communities. One goal determining 214 the network-based communities, is to obtain information about network-based communities in the edge system or systems. In one example, edged devices connect to each other as a network that can be modeled as a undirected graph. In this graph, each node represents one edge device and there is a link between two nodes if there is at least one logical connection between the respective device pairs. Edge devices such as routers, switches, wireless access-points, cellphones, IoT devices, and even servers can be modeled into nodes. A logical connection can be a wired connection (e.g., an Ethernet connection) and/or or a wireless connection.

With the graph information about nodes or devices in a network, the network-based communities may be obtained in at least two ways: (1) by receiving information regarding communities from data originating from the network itself, and (2), by applying an assortative community detection operation to detect the information about the network-based communities. These community detection algorithms employ techniques to find subsets of nodes in the network that are tightly and densely connected.

Thus, if community-based information is available (Y at 216), the method 200a proceeds to determining 220 the task-based communities. If the community information is not available (N at 216), community detection operations are performed 218. In either case, step 2 is configured to determine or identify the network-based communities.

Obtaining information regarding network-based communities is relevant because edges that connect nodes from the same network-based community (e.g., intra-community edge devices) may perform tasks more efficiently compared to edge devices from different network-based communities. One reason is that due to the proximity between nodes and the presence of a greater number of connections between devices in the same network-based community, gains may include lower latencies, improved robustness, fewer connection failures, or the like.

In one example, determining 220 network-based communities may be delegated to a detection engine that operates in the background. The detection engine could, as a result, keep up-to-date information available for the method 200a regarding current network-based communities. Further, embodiments of the invention contemplate both static and dynamic scenarios. In dynamic scenarios, for example, the network-based communities may be updated continually, periodically, or the like and dynamically adjust to changing network conditions.

After determining 214 the network-based communities, task-based communities are determined 220. In step 3 (206), one objective is to identify nodes or devices in the network that match the archetypal devices generated or identified in step 1 (202). This allows task-based communities to be created or identified. Advantageously, nodes or devices performing a task benefit by exchanging information with other devices that solve similar tasks.

However, task-based communities may not match network-based communities. As a result, embodiments of the invention may ensure that the task-based communities and the network-based communities are identified correctly to the extent possible.

In one example, the graph is searched 222 for devices that match the archetypal devices determined in step 1 (202). This may be performed using a partially observed graph search technique to find task-based communities. In one embodiment, an active search operation is performed to search for nodes in the graph with a certain set of features or labels. The features of the nodes are based on the archetypes generated or determined in step 1 (202). The search may also be constrained by computational power, the presence of accelerators, the availability of sensors, or the like. The set of nodes identified by the search are returned 226 in step 3 (206).

Once the network-based communities and the task-based communities are identified, the method 200a aligns 228 the network and task-based communities. This includes determining whether the devices from the same task-based community belong to the same network-based community. This does not require a one-to-one correspondence. Rather, a match may be determined (Y at 230) when all of the devices in the task-based community are in the same network-based community (other devices in the network-based community may be present that are not part of the task-based community).

If a match is not determined (N at 230), a virtual private network (VPN) may be defined and resources are provisioned 232 such that the task-based community and the network-based community match. The method 200a may then end 234 in one example.

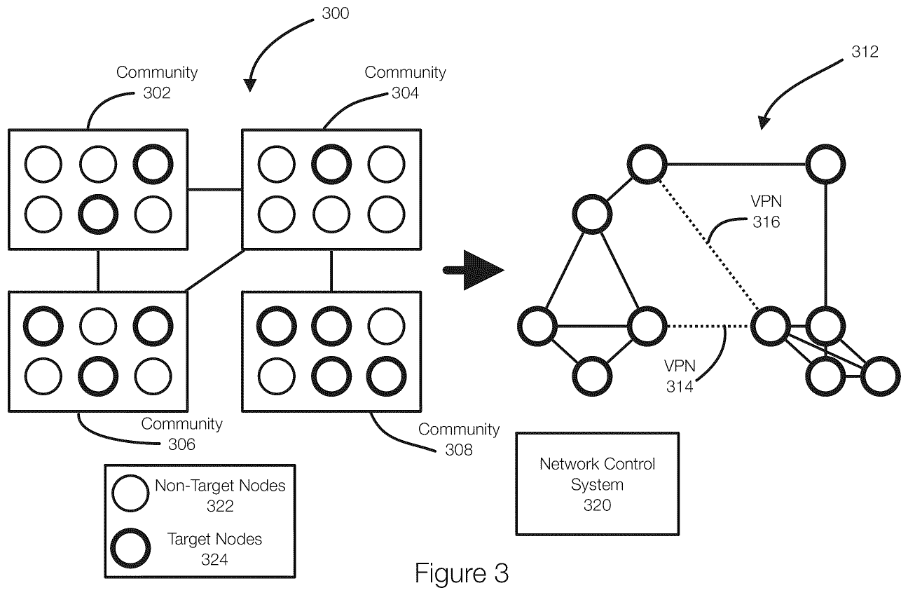

By aligning 208 the network-based and task-based communities, mismatches between nodes of two communities that are not paired, thereby harming or reducing the effectiveness of the system, are avoided. Establishing a network connection and providing resources ensures that there is a match between the network and task-based communities, thereby improving performance. The connection can be removed once the task is completed in one example. In another example, the connection and respective network resources may be available for some pre-defined time if tasks tend to repeat over time or for other reasons. In another embodiment, the more frequently the task is executed, the longer the connections and resources are maintained and made available. The network control system (e.g., 320 in FIG. 3) may maintain information regarding these connections and may determine when to remove the connections. In one example, the network-based community information may be updated to reflect these connections when available such that these connections, which may be temporary, are considered when determining whether a task-based community aligns with a network-based community. Alternatively,

[symbol]

More specifically, as illustrated in the method 200, if devices from the same task-based community belong to the same network-based community (Y at 222), there is no need to take any action. If the devices from the same task-based community do not belong to the same network-based community (N at 222), a VPN is defined to include the devices of the task-based community into a network-based virtual community. In addition, enhancements can be performed such enabling stronger cryptographic algorithms or generating redundant communication paths for more robust data flow.

FIG. 3 discloses aspects of orchestrating tasks, which may include aspects of aligning network-based communities and task-based communities. In this example, a graph 300 May include network-based communities 302, 304, 406, and 308. Based on archetypal examples, a graph is searched and the nodes returned by the search are part of a task-based community that is illustrated in heavier line or bold. As illustrated, the task-based community 312 includes nodes (or devices) that are not part of the same network-based communities. There is thus a mismatch in this example.

In this example, connections between the network-based community 302 and the network-based community 308 and connections between the network-based community 306 and the network-based community 308 are not present. To ensure that the task-based community 312 matches with a network-based community, VPN connections 314 and 216 are created.

More specifically a network control system 320 may be provided (e.g., an SDN-based single point system) that is configured to monitor and manage the entire network infrastructure. As a result, connections including VPN connects can be created/removed as needed such that network-based communities and task-based communities match or overlap.

After creating a network-based virtual community, as illustrated in FIG. 3, a network rewiring operation may be performed to create or reinforce inter-community connectivity. This may improve network robustness while decreasing latency. Additionally, this approach allows communication flows to be balanced among devices in each community.

The dynamic infrastructure may use/create resources such as virtual machines and/or virtual network functions. These resources may enable dynamic resource allocation such as provisioning one or more network resources and functions to serve the VPN during the task. In one example, traffic is optimized within the network-based communities by allocating more bandwidth resources or by avoiding congested paths. The traffic within the network-based communities may be optimized by allocating more bandwidth resources or avoiding congested routes. Embodiments of the invention thus improve at least device to device communications.

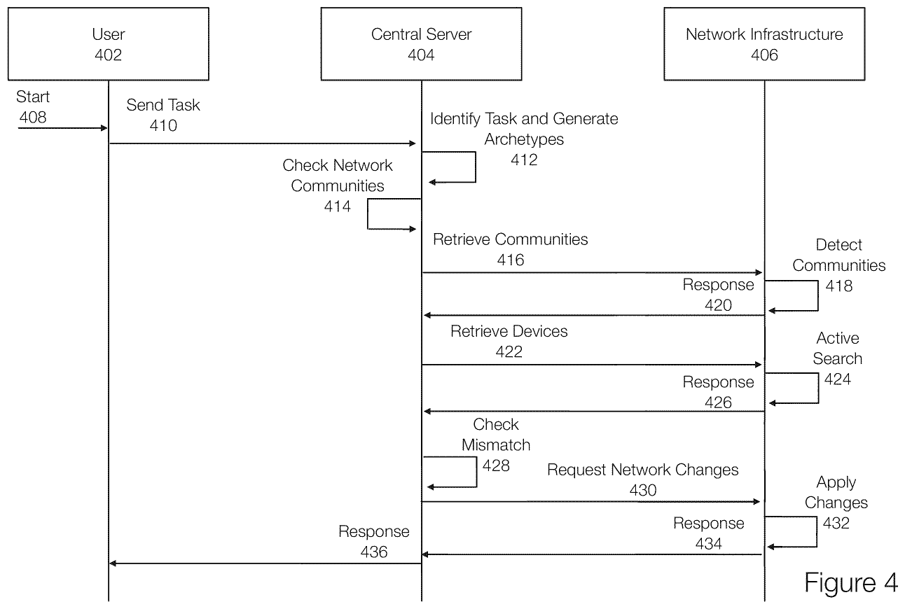

FIG. 4 discloses aspects of a method for orchestrating tasks in a computing environment. The method of FIG. 4 focuses on creating a scenario where a task-based community is aligned with a network-based community. This allows tasks to be performed collaboratively and more efficiently by creating, as needed and by way of example, VPNs and VNFs.

FIG. 4 illustrates a user 402 (e.g., a user, an orchestration engine configured to orchestrate tasks in a computing environment, or the like), a central server 404, and network infrastructure 406. The central server 404 may include a network control system to interact with the network infrastructure 406.

In this example, the method starts 408 when a task is received. The user 402 sends 410 the task to the central server 404 and the central server 404 identifies the task and generates 412 at least one archetypal device.

Next, the central server 404 may check 414 to determine whether information regarding network-based communities is available. If not, the network-based communities are retrieved 416 from the network infrastructure 406. If necessary, retrieving network-based communities includes detecting 418 network-based communities. A response 420 including the network-based community data may be returned.

Next, devices able to perform the task are retrieved 422. This may include performing an active search 424 on a graph to identify suitable nodes (devices) that satisfy the requirements of the archetypal device including hard/soft constraints. The response 426 includes the device information or nodes that were found during the search. These nodes or devices form a task-based community.

The central server 404 checks 428 for a match between the network and task-based communities. If the task-based community does not match the network-based community, network changes are requested 430 and applied 432. A response 434 indicates that the changes (e.g., resource allocation, VPN and VNF creation) have been allocated or implemented. The response 436 is then returned to the user 402 and the task is placed in the computing environment at one of the nodes and performed. As necessary, information is exchanged between the devices in the task-based community as needed to collaboratively perform the task.

When orchestrating tasks, various situations may occur or be considered. For example, the user 402 may add an order of execution to the tasks, prioritize the tasks, or the like. The user 402 (or central server 404) may perform load balancing such that no single device is heavily used while other devices are used less.

Orchestrating tasks to account for these scenarios may be handled prior to step 1 (202). For example, if two tasks need to be executed in order, these two tasks (and their respective archetypes) can be fed serially to the system and then combined afterwards by a third external system. Another example is starting the search process for the various tasks in different parts of the network to avoid over usage of some devices. Defining the order of execution, search start location, and the like may alleviate these potential concerns.

In one example, device A is solving task X, and, during the search, A is the only known device to solve task Y that fits the archetype being searched. This scenario may be solved, for instance, by waiting for X to finish, thus freeing the resources of device A. However, this may stop the search process for an unknown amount of time. Alternatively, the search for a device of the same archetype of device A may continue. This approach will need more queries to the network, but it will not stop the process.

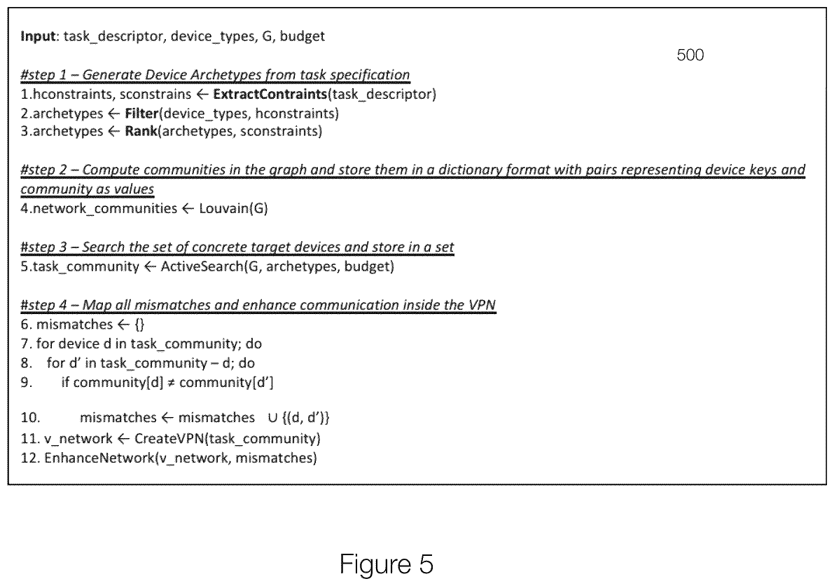

FIG. 5 illustrates an example of pseudocode for orchestrating tasks in a computing environment. The pseudocode 500 assumes that (i) network community information is unavailable, and that (ii) the active search always returns a non-empty set of real and available devices. In this example, the dictionary notation follows from Python's notation in which dictionary entries are ordered pairs of type (key,value) and accessed through the keys (i.e., dictionary [key] returns value). Inputs in the pseudocode include a task description file, a set of device types which are known to compose the whole network (servers, desktops, cameras, tablets, etc.), a graph snapshot G of the network, and a budget allowance for the active search step.

In one example, a task description file is a structure document that contains information with regards to hard and soft constraints as well as other information such as name, author, and general description. Extracting constraint information (line 1) is dependent upon the format which the task is specified. This is useful because the constraint information specifies the computer resources that are needed to accomplish the task within a timeframe. Constraints can be provided directly by the user or based on automatic historical analysis of similar tasks. This document can be a simple json file and its constraint specification granularity is task dependent as some tasks may require more rigorous and finer types of resources while others may require simple specification such as “{“description”:“A simple ML task”, “gpus”:“2”, “mem”:“32GB”}”. Other description formats such as from the SLURM workload orchestrator can be used.

Next, all types of devices that do not satisfy the hard constraints (line 2) are filtered. The remaining devices are the archetype devices. These archetype devices may be then ranked according to their soft constraints.

After ranking the archetypes, the example performs a common community detection operation (line 4) (e.g., Louvain) to find or identify the network-based communities. After identifying the network-based communities, an active search is in the network for the physical devices using the archetypes (line 5). Budget may be required to perform the active search in the network. Next, the pseudocode identifies mismatches. For example, when two devices in the same task-based community do not fall within the same network-based community (lines 6-10), a mismatch is identified. With this set of mismatches, the example proceeds to make the network enhancements (lines 11-12) such that the network and task-based communities are aligned.

Embodiments of the invention thus identify and group devices that are suited for solving similar tasks and facilitate communication protocols and paths to improve the performance of solving tasks collaboratively.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, community detection operations, archetypal device related operations, network and task-based community alignment operations, task placement and orchestration operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for orchestrating a task in a computing environment, the method comprising: determining a set of archetypal devices for performing a task, determining network-based communities in the computing environment, determining a task-based community in the computing environment, wherein the task-based community includes devices configured to perform the task, aligning the task-based community with the network-based communities, and performing the task in the task-based community that is aligned with the network-based communities in a collaborative manner.

Embodiment 2. The method of embodiment 1, wherein the archetypal device comprises a virtual device having a set of features to be matched against real devices represented in nodes of a graph.

Embodiment 3. The method of embodiment 1 and/or 2, wherein the set of features comprises a type of task, wherein devices associated with the type of task are capable of performing the task, wherein at least some of the devices are included in the task-based community.

Embodiment 4. The method of embodiment 1, 2, and/or 3, further comprising searching a graph to identify devices to include in the task-based community, wherein the graph comprises nodes and each node represents a unique device.

Embodiment 5. The method of embodiment 1, 2, 3, and/or 4, further comprising performing an active search in the graph to identify the devices to include in the task-based network.

Embodiment 6. The method of embodiment 1, 2, 3, 4, and/or 5, wherein the network-based communities are identified in a background operation and available upon request.

Embodiment 7. The method of embodiment 1, 2, 3, 4, 5, and/or 6, further comprising that no action is needed to align the task-based community with the network-based communities.

Embodiment 8. The method of embodiment 1, 2, 3, 4, 5, 6, and/or 7, further comprising: determining that the task-based community is not matched to the network-based communities, and requesting network changes such that the task-based community is aligned with the network-based community.

Embodiment 9. The method of embodiment 1, 2, 3, 4, 5, 6, 7, and/or 8, wherein the changes include allocating resources for and implementing at least one of a virtual private network and virtual network functions.

Embodiment 10. The method of embodiment 1, 2, 3, 4, 5, 6, 7, 8, and/or 9, wherein the changes further include rewiring operations to create and/or reinforce inter-community connectivity, performing encryption operations, optimizing traffic, and/or generating redundant communication flows.

Embodiment 11. The method of embodiment 1, 2, 3, 4, 5, 6, 7, 8, 9, and/or 10, further comprising filtering devices determined for the task-based community based on hard and/or soft constraints.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These May be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

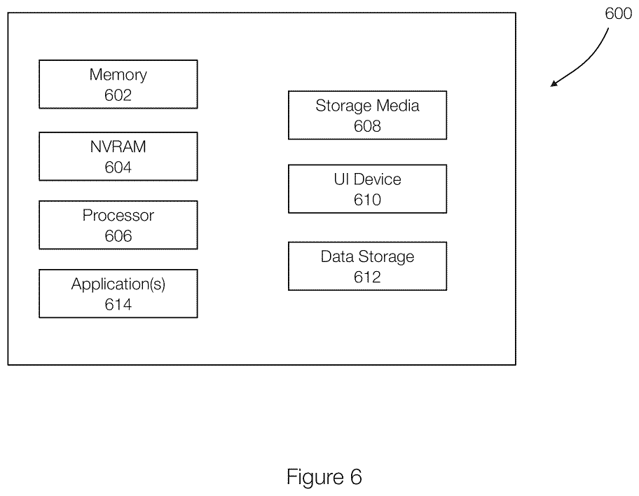

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, community-based networks, task-based communities, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for orchestrating a task in a computing environment, the method comprising:
determining a set of archetypal devices for performing a task;
determining network-based communities in the computing environment;
determining a task-based community in the computing environment, wherein the task-based community includes devices configured to perform the task;
aligning the task-based community with the network-based communities; and
performing the task in the task-based community that is aligned with the network-based communities in a collaborative manner.

2. The method of claim 1, wherein the archetypal device comprises a virtual device having a set of features to be matched against real devices represented in nodes of a graph.

3. The method of claim 1, wherein the set of features comprises a type of task, wherein devices associated with the type of task are capable of performing the task, wherein at least some of the devices are included in the task-based community.

4. The method of claim 3, further comprising searching a graph to identify devices to include in the task-based community, wherein the graph comprises nodes and each node represents a unique device.

5. The method of claim 4, further comprising performing an active search in the graph to identify the devices to include in the task-based network.

6. The method of claim 1, wherein the network-based communities are identified in a background operation and available upon request.

7. The method of claim 1, further comprising that no action is needed to align the task-based community with the network-based communities.

8. The method of claim 1, further comprising:
determining that the task-based community is not matched to the network-based communities; and
requesting network changes such that the task-based community is aligned with the network-based community.

9. The method of claim 8, wherein the changes include allocating resources for and implementing at least one of a virtual private network and virtual network functions.

10. The method of claim 9, wherein the changes further include rewiring operations to create and/or reinforce inter-community connectivity, performing encryption operations, optimizing traffic, and/or generating redundant communication flows.

11. The method of claim 1, further comprising filtering devices determined for the task-based community based on hard and/or soft constraints.

12. A non-transitory storage medium having stored therein instructions that are executable by one or more hardware processors to perform operations comprising:
determining a set of archetypal devices for performing a task;
determining network-based communities in the computing environment;
determining a task-based community in the computing environment, wherein the task-based community includes devices configured to perform the task;
aligning the task-based community with the network-based communities; and
performing the task in the task-based community that is aligned with the network-based communities in a collaborative manner.

13. The non-transitory storage medium of claim 12, wherein the archetypal device comprises a virtual device having a set of features to be matched against real devices represented in nodes of a graph, wherein the set of features comprises a type of task, wherein devices associated with the type of task are capable of performing the task, wherein at least some of the devices are included in the task-based community.

14. The non-transitory storage medium of claim 13, further comprising searching a graph to identify devices to include in the task-based community, wherein the graph comprises nodes and each node represents a unique device.

15. The non-transitory storage medium of claim 14, further comprising performing an active search in the graph to identify the devices to include in the task-based network and further comprising filtering devices determined for the task-based community by the search based on hard and/or soft constraints.

16. The non-transitory storage medium of claim 12, wherein the network-based communities are identified in a background operation and available upon request.

17. The non-transitory storage medium of claim 12, further comprising that no action is needed to align the task-based community with the network-based communities.

18. The non-transitory storage medium of claim 12, further comprising:
determining that the task-based community is not matched to the network-based communities; and
requesting network changes such that the task-based community is aligned with the network-based community.

19. The non-transitory storage medium of claim 18, wherein the changes include allocating resources for and implementing at least one of a virtual private network and virtual network functions.

20. The non-transitory storage medium of claim 19, wherein the changes further include rewiring operations to create and/or reinforce inter-community connectivity, performing encryption operations, optimizing traffic, and/or generating redundant communication flows.
